(19) United States
(12) Patent Application Publication
(10) Pub. No.: US 2012/0269039 A1
(43) Pub. Date: Oct. 25, 2012

(54) AIRBORNE ULTRASONIC SENSOR

(75) Inventors: Koji Ibata, Tokyo (JP); Tomonori Kimura, Tokyo (JP); Satoru Inoue, Tokyo (JP)

(73) Assignee: MITSUBISHI ELECTRIC CORPORATION, Tokyo (JP)

(21) Appl. No.: 13/512,043

(22) PCT Filed: Dec. 2, 2009
(86) PCT No.: PCT/JP2009/070221

§ 371 Date: May 25, 2012

(51) Int. Cl. G01S 7/521

(52) U.S. Cl. 367/180

(57) ABSTRACT

An airborne ultrasonic sensor capable of obtaining an asymmetric directivity pattern in a predetermined direction with a simple structure. The airborne ultrasonic sensor includes: a case whose one end is open and another end is a closed surface, so as to have a hollow portion; and a piezoelectric element which is disposed on an inner side of the closed surface, the closed surface being a vibration surface, in which the case has a side surface at least partially provided with a region which is obtained by removing the side surface from an opening surface side. The closed surface has a circular, elliptical, oval, square, or rectangular shape.

### TECHNICAL FIELD

The present invention relates to an airborne ultrasonic sensor for radiating ultrasound into the air and receiving a reflected wave from an ambient object, thereby detecting the presence or absence of an obstacle.

### BACKGROUND ART

An airborne ultrasonic sensor of this type uses a piezoelectric element to radiate ultrasound into the air, and receives a reflected wave reflected from an obstacle or the like. The airborne ultrasonic sensor is used in systems such as an obstacle detection system for detecting an obstacle. For example, the airborne ultrasonic sensor is used in a detection system to be mounted on a vehicle such as an automobile (see, for example, Patent Literatures 1 and 2).

In Patent Literature 1, an airborne ultrasonic sensor includes a box-shaped case body whose one surface is open, and a piezoelectric element disposed on the bottom of the case body. The case body includes a metal case and a synthetic resin case. The metal case is formed of a metal plate member, and has a substantially rectangular vibration portion which is formed to have a predetermined aspect ratio and on which the piezoelectric element is mounted. In one surface of the resin case, an accommodation recess for accommodating the metal case is open. The metal case is disposed in the accommodation recess in a state in which the vibration portion of the metal case is exposed to the outside from a window hole provided at the bottom of the accommodation recess. The vibration portion of the metal case, on which the piezoelectric element is mounted, is exposed to the outside from the window hole provided at the bottom of the accommodation recess, and the aspect ratio of the vibration portion is set to a predetermined ratio, and hence an airborne ultrasonic sensor capable of adjusting the directivity of ultrasound can be obtained.

Further, Patent Literature 2 describes an ultrasonic transceiver in which a piezoelectric element is bonded on the inner side of a bottom surface of a bottomed cylindrical case, which is provided with a ditch so that the width is relatively long in one direction and relatively short in another direction, to thereby constitute unimorph vibration. The ultrasonic transceiver transmits and receives ultrasound at the case outer side of this vibrator. On the relatively short side surface of the bottomed cylindrical case, an opening portion whose width does not exceed the width of the side surface is provided, thereby narrowing directivity characteristics. Therefore, when those airborne ultrasonic sensors are mounted onto a bumper of an automobile, it is possible to obtain anisotropic directivity which is wider in the direction parallel to a road surface and narrower in the direction perpendicular to the road surface.

### CITATION LIST

### Patent Literature

[PTL 1] JP 2001-235539 A

[PTL 2] JP 2006-345271 A

### SUMMARY OF INVENTION

### Technical Problem

In those airborne ultrasonic sensors, however, the directivity in the direction parallel to the road surface or in the direction perpendicular to the road surface has a directivity pattern symmetric about the airborne ultrasonic sensor. For example, in order to detect an obstacle on the road surface, directivity characteristics in the direction perpendicular to the road surface needs to be wide on the road surface side but may be narrow in the direction opposite to the road surface, that is, on the sky side because no detection target is present. Accordingly, for this detection, an airborne ultrasonic sensor having an asymmetric pattern of directivity characteristics is desired. However, the conventional airborne ultrasonic sensors have a problem that an asymmetric directivity pattern in a predetermined direction cannot be obtained.

The present invention has been made for solving the above-mentioned problem, and it is an object thereof to provide an airborne ultrasonic sensor capable of obtaining an asymmetric directivity pattern in a predetermined direction with a simple structure.

### Solution to Problem

An airborne ultrasonic sensor according to the present invention includes: a case whose one end is open and another end is a closed surface, so as to have a hollow portion; and a piezoelectric element which is disposed on an inner side of the closed surface, the closed surface being a vibration surface, in which the case has a side surface at least partially provided with a region which is obtained by removing the side surface from an opening surface side.

### Advantageous Effects of Invention

According to the present invention, the region obtained by removing the side surface from the opening surface side is provided in at least apart of the side surface of the case. Thus, ultrasound radiated by vibration of the side surface of the case is not generated. Therefore, as a result of the asymmetric sensor structure, an asymmetric directivity pattern in a predetermined direction can be obtained with a simple structure.

### BRIEF DESCRIPTION OF DRAWINGS

FIG. 1 are schematic views illustrating an airborne ultrasonic sensor according to a first embodiment of the present invention, in which FIG. 1(a) is a side view and FIG. 1(b) is a top view.

FIG. 2 is a diagram illustrating simulation results on directivity characteristics of the airborne ultrasonic sensor according to the first embodiment of the present invention.

FIG. 3 are views illustrating the structure of the airborne ultrasonic sensor used in the simulation of FIG. 2, in which FIG. 3(a) is a cross-sectional view taken along the line A-A′ of FIG. 3(b) and FIG. 3(b) is a side view illustrating a two-dimensional planar model.

FIG. 4 is a diagram illustrating simulation results on directivity characteristics of an airborne ultrasonic sensor corresponding to a conventional example.

FIG. 5 are views illustrating the structure of the airborne ultrasonic sensor used in the simulation of FIG. 4, in which FIG. 5(a) is a cross-sectional view taken along the line A-A′ of FIG. 5(b) and FIG. 5(b) is a side view illustrating a two-dimensional planar model.

FIG. 6 is a view illustrating an example in which a closed surface of a case 1 in the airborne ultrasonic sensor of FIG. 1 has a substantially circular shape.

FIG. 7 is a view illustrating an example in which the closed surface of the case 1 in the airborne ultrasonic sensor of FIG. 1 has a substantially oval shape.

FIG. 8 is a view illustrating an example in which the closed surface of the case 1 in the airborne ultrasonic sensor of FIG. 1 has a substantially square shape.

FIG. 9 is a view illustrating an example in which the closed surface of the case 1 in the airborne ultrasonic sensor of FIG. 1 has a substantially rectangular shape.

### DESCRIPTION OF EMBODIMENT

### Embodiment 1

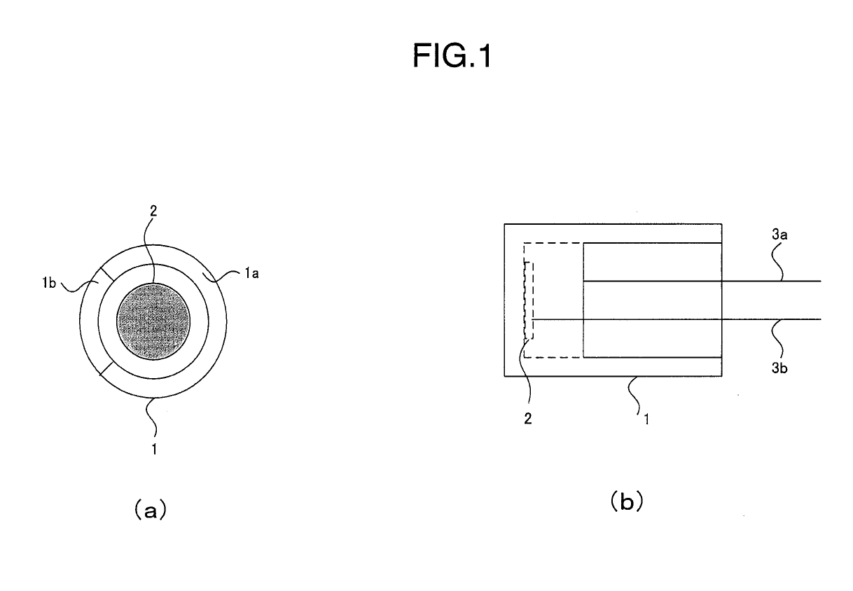

An airborne ultrasonic sensor according to a first embodiment of the present invention is described with reference to the drawings. FIG. 1 are schematic views illustrating the airborne ultrasonic sensor according to the first embodiment of the present invention. FIG. 1(a) is a side view and FIG. 1(b) is a top view. The airborne ultrasonic sensor includes a case 1 and a piezoelectric element 2. One end of the case 1 is open, and the other end is a closed surface. The piezoelectric element 2 has a circular flat shape and is provided on the inner side of the closed surface of the case 1. The piezoelectric element 2 is fixedly adhered onto a center position of the inner side of the closed surface of the case 1 by an adhesive or the like. An input/output terminal 3a is connected to the case 1. An input/output terminal 3b is connected to the piezoelectric element 2 on the surface opposite to the bonding surface to the case 1.

The case 1 is made of, for example, a glass-cloth reinforced resin having relatively high rigidity or a metal such as aluminum. The case 1 has a side surface 1a at least partially provided with a region 1b which is obtained by removing the side surface 1a from the opening surface side. Thus, the opposing surfaces have an asymmetric shape. The piezoelectric element 2 is formed of a piezoelectric ceramic such as PZT or barium titanate. In the airborne ultrasonic sensor according to the first embodiment, a drive signal is applied from the input/output terminals 3a and 3b to vibrate the piezoelectric element 2, and ultrasound can thus be generated.

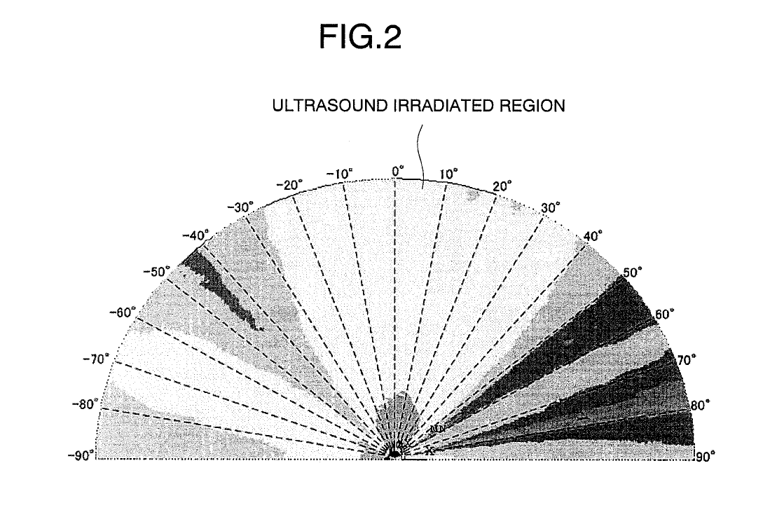

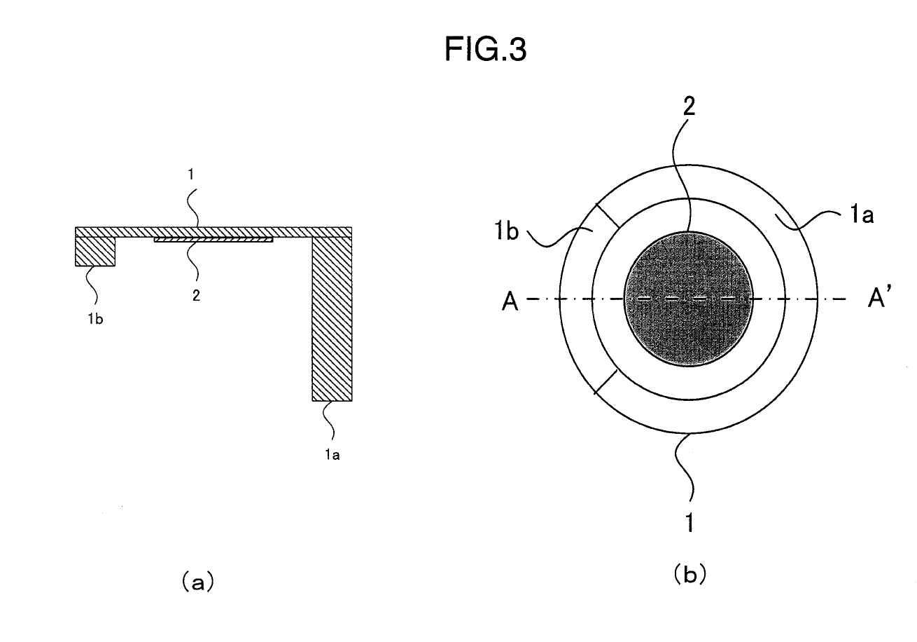

FIG. 2 shows simulation results on directivity characteristics of the airborne ultrasonic sensor according to the first embodiment. FIG. 3 are views illustrating the structure of the airborne ultrasonic sensor used in the simulation. FIG. 3(a) illustrates the cross section taken along the line A-A′ of FIG. 3(b). Note that, as a simulation model in the simulation, a two-dimensional planar model illustrated in FIG. 3(a) is used.

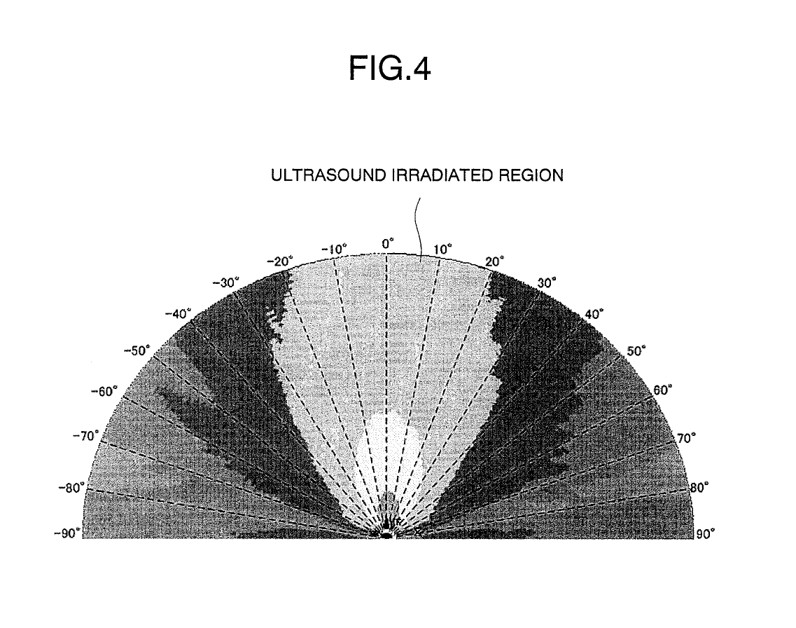

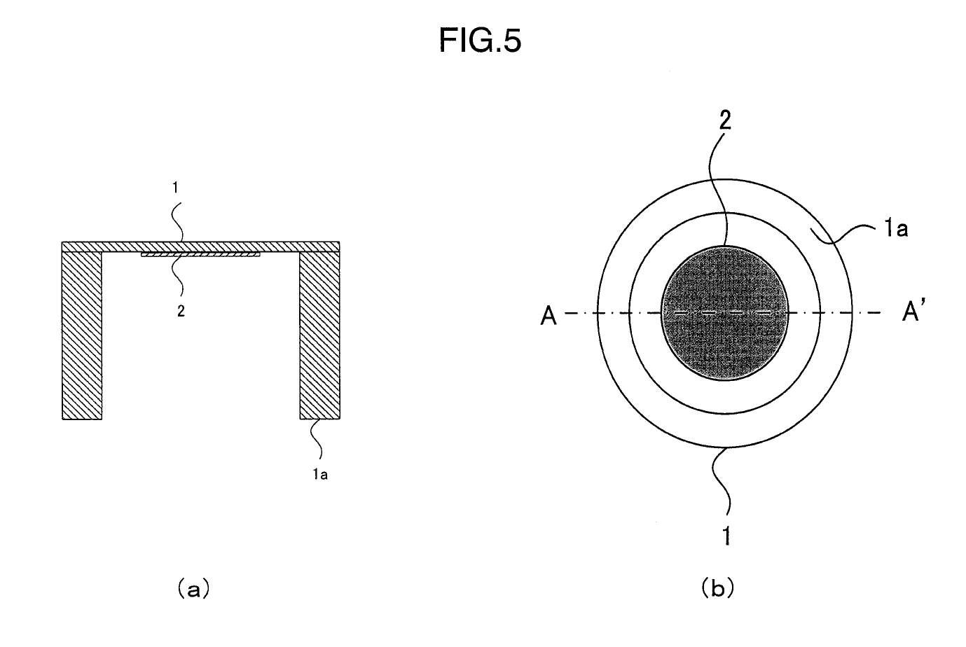

For comparison, simulation results on directivity characteristics of an airborne ultrasonic sensor corresponding to the conventional example are shown. FIG. 4 shows the simulation results on the directivity characteristics of the airborne ultrasonic sensor corresponding to the conventional example. FIG. 5 are views illustrating the structure of the airborne ultrasonic sensor used in the simulation. FIG. 5(a) illustrates the cross section taken along the line A-A′ of FIG. 5(b). Note that, as a simulation model in the simulation, a two-dimensional planar model illustrated in FIG. 5(a) is used. FIG. 2 and FIG. 4 show a sound pressure distribution within a radius of 20 cm in the case where the sensor is disposed at the center of the semicircle. The intensity of the sound pressure is represented by color density. A light-colored region represents a region with high sound pressure, that is, a region irradiated with strong ultrasound.

The airborne ultrasonic sensor according to the first embodiment is provided with the region 1b, which is obtained by removing at least a part of the side surface 1a of the case 1 from the opening surface side. Thus, ultrasound radiated by vibration of the side surface of the case is not generated. Therefore, as a result of the asymmetric sensor structure, as shown in FIG. 2, the region irradiated with strong ultrasound in the front direction ranges from the vicinity of −30° to the vicinity of 40°, resulting in directivity characteristics asymmetric about 0°.

On the other hand, in the airborne ultrasonic sensor of the conventional example, the side surface 1a of the case 1 has no removed region 1b, and hence ultrasound radiated by vibration of the side surface of the case is generated. Therefore, the sensor structure is symmetric, and hence, as shown in FIG. 4, the region irradiated with strong ultrasound in the front direction ranges from the vicinity of −20° to the vicinity of 20°, resulting in directivity characteristics symmetric about 0°.

In this way, according to the airborne ultrasonic sensor of the first embodiment, it is possible to obtain directivity characteristics laterally asymmetric about the airborne ultrasonic sensor. Therefore, when the airborne ultrasonic sensor is mounted onto a bumper of an automobile so that the directivity characteristics are narrower on the sky side and wider on the road surface side, it is possible to obtain anisotropic directivity characteristics which are wider on the road surface side and narrower on the side opposite to the road surface.

Further, the directivity characteristics of the airborne ultrasonic sensor according to the first embodiment can be adjusted by the area of the case 1 to be removed. That is, in the above description, the side having narrower directivity characteristics corresponds to the side on which the region lb obtained by removing the side surface of the case 1 is present in FIG. 1, and in the simulation results on directivity characteristics shown in FIG. 2, the negative angle side corresponds to directivity characteristics to which a region with the region lb contributes, and the positive angle side corresponds to directivity characteristics to which a region without the region 1b contributes. In the airborne ultrasonic sensor, ultrasound is radiated in a manner that vibration at the closed surface of the case 1 (the surface opposite to the side on which the piezoelectric element 2 is provided) is dominant, but vibration of the side surface of the case 1 also contributes to the radiation of ultrasound.

Therefore, as the area of the side surface of the case 1 is increased (the area of the removed region lb is decreased), the vibration range of the case 1 becomes larger, and the range to be irradiated with ultrasound also becomes larger, resulting in wider directivity characteristics. On the other hand, as the area of the side surface of the case 1 is decreased (the area of the removed region 1b is increased), the vibration range becomes smaller, and the range to be irradiated with ultrasound becomes smaller, resulting in narrower directivity characteristics. In this way, the directivity characteristics of the airborne ultrasonic sensor according to the first embodiment can be adjusted by the area of the case 1 to be removed.

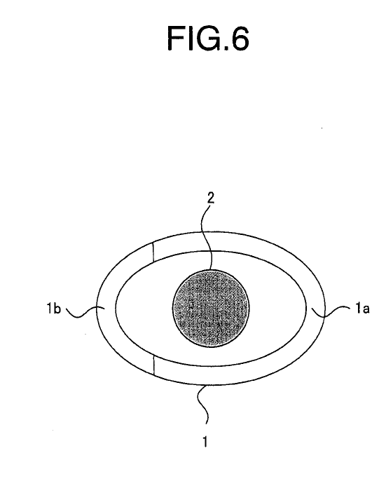

Further, in the first embodiment described above, the shape of the closed surface of the case 1 is substantially circular, but the shape is not limited thereto. The same effects can be obtained also by a structure as illustrated in FIG. 6 in which the closed surface of the case 1 has a substantially elliptical shape and the region 1b obtained by removing the side surface of the case 1 is provided.

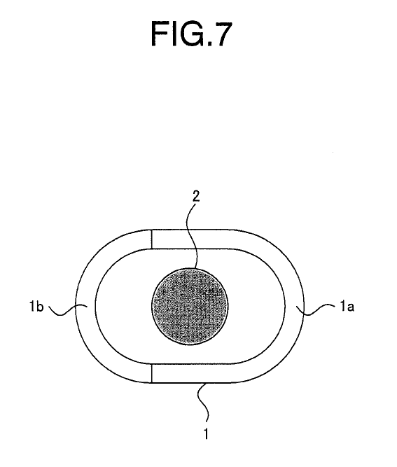

Further, in the first embodiment described above, the shape of the closed surface of the case 1 is substantially circular, but the shape is not limited thereto. The same effects can be obtained also by a structure as illustrated in FIG. 7 in which the closed surface of the case 1 has a substantially oval shape and the region 1b obtained by removing the side surface of the case 1 is provided.

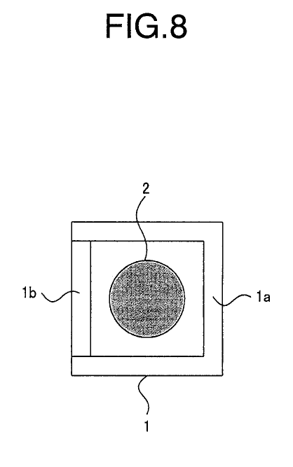

Further, in the first embodiment described above, the shape of the closed surface of the case 1 is substantially circular, but the shape is not limited thereto. The same effects can be obtained also by a structure as illustrated in FIG. 8 in which the closed surface of the case 1 has a substantially square shape and the region 1b obtained by removing the side surface of the case 1 is provided.

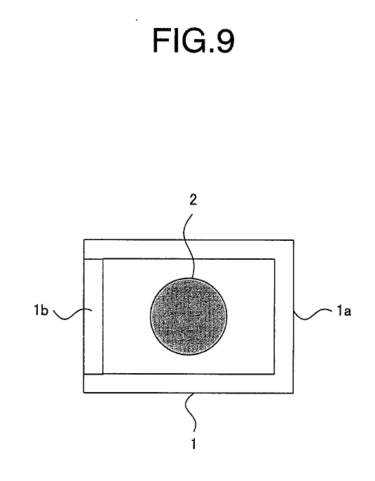

Further, in the first embodiment described above, the shape of the closed surface of the case 1 is substantially circular, but the shape is not limited thereto. The same effects can be obtained also by a structure as illustrated in FIG. 9 in which the closed surface of the case 1 has a substantially rectangular shape and the region 1b obtained by removing the side surface of the case 1 is provided.

### INDUSTRIAL APPLICABILITY

The present invention is used in systems such as an obstacle detection system for detecting an obstacle, in particular, a detection system to be mounted on a vehicle such as an automobile.

### REFERENCE SIGNS LIST

1 case, 1a side surface of case 1, 1b region removed from opening surface side, 2 piezoelectric element, 3a, 3b input/output terminal.

1. An airborne ultrasonic sensor, comprising:
a case whose one end is open and another end is a closed surface, so as to have a hollow portion; and
a piezoelectric element which is disposed on an inner side of the closed surface, the closed surface being a vibration surface,
wherein the case has a side surface at least partially provided with an asymmetric region which is obtained by removing the side surface from an opening surface side.

2. An airborne ultrasonic sensor according to claim 1, wherein the closed surface has a circular shape.

3. An airborne ultrasonic sensor according to claim 1, wherein the closed surface has an elliptical shape.

4. An airborne ultrasonic sensor according to claim 1, wherein the closed surface has an oval shape.

5. An airborne ultrasonic sensor according to claim 1, wherein the closed surface has a square shape.

6. An airborne ultrasonic sensor according to claim 1, wherein the closed surface has a rectangular shape.
